(19) United States
(12) Patent Application Publication
(10) Pub. No.: US 2010/0309226 A1
(43) Pub. Date: Dec. 9, 2010

(54) METHOD AND SYSTEM FOR IMAGE-BASED INFORMATION RETRIEVAL

(75) Inventors: Till Quack, Zurich (CH); Herbert Bay, Zurich (CH)

Correspondence Address: KNOBBE MARTENS OLSON & BEAR LLP, 2040 MAIN STREET, FOURTEENTH FLOOR, IRVINE, CA, 92614, US

(73) Assignees: EIDGENOSSISCHE TECHNISCHE HOCHSCHULE ZURICH, Zurich (CH); KOOABA AG, Zurich (CH)

(21) Appl. No.: 12/599,279

(22) PCT Filed: May 8, 2007
(86) PCT No.: PCT/CH07/00230

§ 371 Date: Jan. 6, 2010

(51) Int. Cl. G06K 9/68; G06K 9/46; G09G 5/00

(52) U.S. Cl. 345/634; 382/218; 382/201

(57) ABSTRACT

For retrieving information based on images, a first image is taken (S1) using a digital camera associated with a communication terminal (1). Query data related to the first image is transmitted (S3) via a communication network (2) to a remote recognition server (3). In the remote recognition server (3) a reference image is identified (S4) based on the query data. Subsequently, in the remote recognition server (3), a Homography is computed (S5) based on the reference image and the query data, the Homography mapping the reference image to the first image. Moreover, in the remote recognition server (3), a second image is selected (S6) and a projection image is computed (S7) of the second image using the Homography. By replacing a part of the first image with at least a part of the projection image, an augmented image is generated (S8, S10) and displayed (S11) at the communication terminal (1). Efficient augmentation of the first image taken with the camera is made possible by remaining in the planar space and dealing with two-dimensional images and objects only.

### FIELD OF THE INVENTION

The present invention relates to a method and a system for information retrieval based on images. Specifically, the present invention relates to a method and a system for information retrieval based on images that are taken using a digital camera and identified in a remote recognition server.

### BACKGROUND OF THE INVENTION

With the availability of low-cost and miniaturized digital (electronic) cameras it was only a matter of time that these cameras were integrated into mobile radio telephones, laptop and PDA (Personal Digital Assistant) computers and other electronic equipment. Particularly, combining the features of a digital camera with the features of a communication terminal opened the door for new applications where images taken by the cameras are transmitted through fixed or wireless communication lines to other communication terminals or to remote servers for further processing.

EP 1640879 describes a method of searching for images in a database. Images are taken using mobile cameras and transmitted via a telecommunications network for storage in a database. Users are assigning metadata to the images, e.g. geographical position data, enabling subsequent searches for images in the database based on this metadata.

EP 1230814 describes a method for ordering products, in which by means of a camera a picture is taken of a product to be ordered. The picture is transmitted to a remote server using a mobile radio telephone. For identifying the desired product, the server compares the received picture to pictures of a product database, e.g. by means of a neuronal network, and initiates an order for the respective mobile subscriber.

DE 10245900 describes a system for image-based information retrieval in which a terminal with a built-in camera transmits images via a telecommunications network to a server computer. The server uses an object recognition program for analyzing received images and assigning symbolic indices to the images. A search engine uses the indices for finding information related to the image and returns this information to the terminal.

US 2006/0240862 describes an image-based information retrieval system including a mobile telephone, a remote recognition server and a remote media server. The mobile terminal comprises a built-in camera and is configured to transmit an image taken by the camera to the recognition server. In an embodiment, the mobile terminal is configured to determine feature vectors from the image and to transmit those to the recognition server. The recognition server matches the incoming image or feature vectors to object representations stored in a database. The recognition server uses multiple engines, specialized to recognize certain classes of patterns, e.g. faces, textured objects, characters or bar codes. Successful recognition leads to textual identifiers of objects. These identifiers are sent to the media server which transmits corresponding multimedia content back to the mobile telephone, e.g. text, images, music, audio clips, or URL links (Uniform Resource Locator) for retrieving the media content using a web browser on the mobile telephone. For example, by submitting a picture of a printed text, a user can obtain additional information about the text, or a picture of a billboard may result in further information about an advertised product.

While the known systems for image-based information retrieval are configured to provide additional information as separate data objects, such as text, sound or images, in response to pictorial data received via a communication network, e.g. an image or corresponding feature vectors, the known systems do not provide image-related information as an integral part of the respective image.

### SUMMARY OF THE INVENTION

It is an object of this invention to provide a method and a system for image-based information retrieval, which system and method do not have the disadvantages of the prior art. In particular, it is an object of the present invention to provide a method and a system for image-based information retrieval which provide image-related information as an integral part of the respective image that was used as the (query) criteria for information retrieval.

According to the present invention, these objects are achieved particularly through the features of the independent claims. In addition, further advantageous embodiments follow from the dependent claims and the description.

According to the present invention, the above-mentioned objects are particularly achieved in that, for retrieving information based on images, a first image is taken using a digital (electronic) camera associated with a communication terminal; query data related to the first image is transmitted via a communication network to at least one remote recognition server; in the remote recognition server, a reference image is identified based on the query data; in the remote recognition server, a perspective transformation matrix, i.e. a Homography, is computed based on the reference image and the query data from the first image, the Homography mapping the reference image plane to the plane of the reference image figuring in the first image; in the remote recognition server, a second image is selected; in the remote recognition server, a projection image of the second image is computed using the Homography; an augmented image is generated by replacing at least a part of the first image with at least a part of the projection image; and the augmented image is displayed at the communication terminal or transmitted to another terminal. Preferably, the communication terminal is a mobile communication terminal configured for wireless communication. Depending on the embodiment, the replacement of the respective part of the first image (the query image) with the part of the projection image is performed on the recognition server or on the communication terminal; accordingly, the projection image is transmitted to the communication terminal (separately) by itself or as part of the augmented query image. In an embodiment, transmitting the projection image or the augmented query image, respectively, comprises transmitting to the communication terminal a link to an information server. Subsequently, the link is activated in the communication terminal and the projection image or the augmented query image, respectively, is retrieved from the information server. The information server may be located on the same or on a different computer than the recognition server. Determining the Homography for mapping the reference image to the query image and determining the projection image of the second image (the modifying image) make it possible to augment efficiently the query image, taken by the user with his camera. Efficient augmentation is made possible by remaining in the planar space and dealing with two-dimensional images and objects only. Unlike in methods of traditional augmented reality, where three-dimensional objects are projected in three-dimensional sceneries, using a plane-to-plane transformation, i.e. a Homography, to replace parts of the query image with corresponding parts of the projection image of a modifying image makes it possible to augment the query image without the need of complex three-dimensional projections, view-point dependent transformations, and calculations of shadows, reflections, etc. Thus, the augmented (query) image is displayed to the user with the projection of the modifying image being an integral part of the query image. Depending on the application and/or user specified operation, a real world object captured in the query image can be presented to the user with additional visual information that would otherwise not be visible in the query image, e.g. the inside of the object (x-ray mode) or the state of the object at an earlier (historical) or future time (time travel mode). Typically, the modifying image is a modified version of the reference image. However, in different applications, the modifying image is independent from the reference image, e.g. transmitted from the communication terminal to the remote recognition server as part of the data related to the query image, or transmitted previously to the remote recognition server by the user or a user community. In a further variant for augmenting the query image with text, the second image is generated based on text data, e.g. transmitted from the communication terminal to the remote recognition server as part of the data related to the query image, or transmitted previously to the remote recognition server by the user or a user community. Also, multiple images (image sequences) can be used to augment the query image.

In one embodiment, transmitting the query data to the remote recognition server includes transmitting the first image (query image) to the remote recognition server. In this embodiment, the reference image is identified by determining the reference image that corresponds to the query image, and the Homography is computed based on the reference image and the query image. In this embodiment, preferably, identifying the reference image includes analyzing pixels of the query image to detect scale-invariant, interest points, assigning a reproducible orientation to each interest point, computing for each interest point a descriptor vector based on derivatives (e.g. differences) of pixel values neighboring the center of the interest point, and matching images by comparing the determined descriptor vectors related to the query image with descriptor vectors stored in a database of the remote recognition server, and selecting from stored images having corresponding descriptor vectors the reference image with interest points that correspond geometrically (again via a Homography or Fundamental Matrix) to the interest points of the query image (the correspondence depends on the Euclidean or other sort of distances). Transmitting the query image to the recognition server and determining the reference image in the recognition server based on the query image have the advantage that the (mobile) communication terminal does not have to be provided with any image processing capability for analyzing the query image.

In an alternative preferred embodiment, the method further comprises determining in the communication terminal the query data (query image) by analyzing pixels of the query image to automatically detect interest points of any invariance towards scale, affine changes, and/or perspective distortions, by assigning a reproducible orientation to each interest point, and by computing for each interest point a descriptor vector based on derivatives (e.g. differences) of pixel values neighboring the center of each interest point. Correspondingly, identifying the reference image includes image matching by comparing the received descriptor vectors related to the query image with descriptor vectors stored in a database of the remote recognition server, and selecting from stored images having corresponding descriptor vectors the reference image with interest points that correspond geometrically to the interest points of the query image (the correspondence depends on the Euclidean or other sort of distances). Determining the descriptor vectors in the (mobile) communication terminal has the advantage that the recognition server does not need to be configured for computing descriptor vectors for query images submitted by a plurality of communication terminals. Furthermore, a client-side computation of the descriptor vectors has the additional advantage of increased user privacy. The actual query image taken by the user is not transmitted via the communication network and, thus, hidden from anyone but the user, because the original query image cannot be derived from the descriptor vectors.

In an embodiment, transmitting query data related to the first image (query image) to the remote recognition server further includes transmitting additional query information, e.g. geographical position information, day time information, calendar date information, historical year information, future year information, user instruction information specifying an operation to be performed at the remote recognition server, and/or biomedical information such as blood pressure information, blood sugar level information and/or heart rate information. Correspondingly, the second image (modifying image) is selected using this additional query information. Thus, the modifying image can be selected in the recognition server specific to the user's current geographical location, the user's current biomedical conditions and/or for defined points in time. Furthermore, in an embodiment, the second image is selected using user profile information, e.g. stored at the remote recognition server. Thus based on the profile associated with the respective user, different pictorial information is returned to the user, e.g. a young and/or female person will receive different information than an elderly and/or male person, respectively. Preferably, also the reference image is identified using some of the additional query information, e.g. the user's current geographical position and/or or the current time/date, to reduce the search space and decrease the time for searching the reference image.

In a further embodiment, the second image (the modifying image) comprises a visual marker, e.g. a graphical label or symbol, indicative of interactive image sections, and the first image (the query image) is displayed with the visual marker as part of the query image. Thus, the query image taken by the camera is automatically augmented such that when the user looks at the query image, interactive areas in the query image are indicated to the user by the visual markers. Preferably, this mode of operation is in continuous (near) real-time such that the query image is taken in a continuous stream as part of taking a video sequence. Furthermore, the part of the projection image that replaces the corresponding part of the query image is kept fixed with respect to a real world object shown in the query image while the camera is taking the video sequence and/or while the real world object is moving. Thus, the visual markers that indicate interactive image sections are shown fixed to the real world objects on the display of the communication terminal. The user can activate selectively the visual markers or the associated interactive image section, respectively, e.g. by pointing and clicking, and/or specify respective operations to be performed. Thus, while displaying the visual marker as part of the first image, user instructions associated with one of the visual markers are received from the user and transmitted to the remote recognition server. In the remote recognition server, based on the user instruction, a third image is selected (a subsequent modifying image) and/or the reference image is modified as the subsequent modifying image. Using the Homography, the remote recognition server computes a projection image of the subsequent modifying image and generates a further augmented image by replacing a part of the first image with at least a part of the projection image of the third image (image sequence). The further augmented image is displayed at the communication terminal. Thus, based on the visual markers displayed in a first augmentation step, the user can use the camera to search for interactive objects among the real world objects and, in a second augmentation step, take an augmented image of such a real world object.

### BRIEF DESCRIPTION OF THE DRAWINGS

The present invention will be explained in more detail, by way of example, with reference to the drawings in which:

FIG. 1 shows a block diagram illustrating schematically an exemplary configuration of a system for information retrieval based on images.

FIG. 2 shows a block diagram illustrating schematically the transformation of a reference image to a query image through Homography, and the transformation of a modifying image to a projection of the modifying image using the Homography.

FIG. 3 shows a flow diagram illustrating an example of a sequence of steps executed for image-based information retrieval according to the present invention.

FIG. 4 shows examples of quadratic descriptor windows of different scales (sizes) around detected (scale-invariant) interest points, aligned with detected orientations.

FIG. 5 shows an example of a discretized circular region with first order derivatives in x-direction (a) and y-direction (b), the interest point being in the centre of the circular region.

FIG. 6 shows an example of descriptor window, centered at the interest point, with scale dependent side length, split up in 16 sub-regions, which are independently considered for the computation of the descriptor vector.

### DETAILED DESCRIPTION OF THE PREFERRED EMBODIMENTS

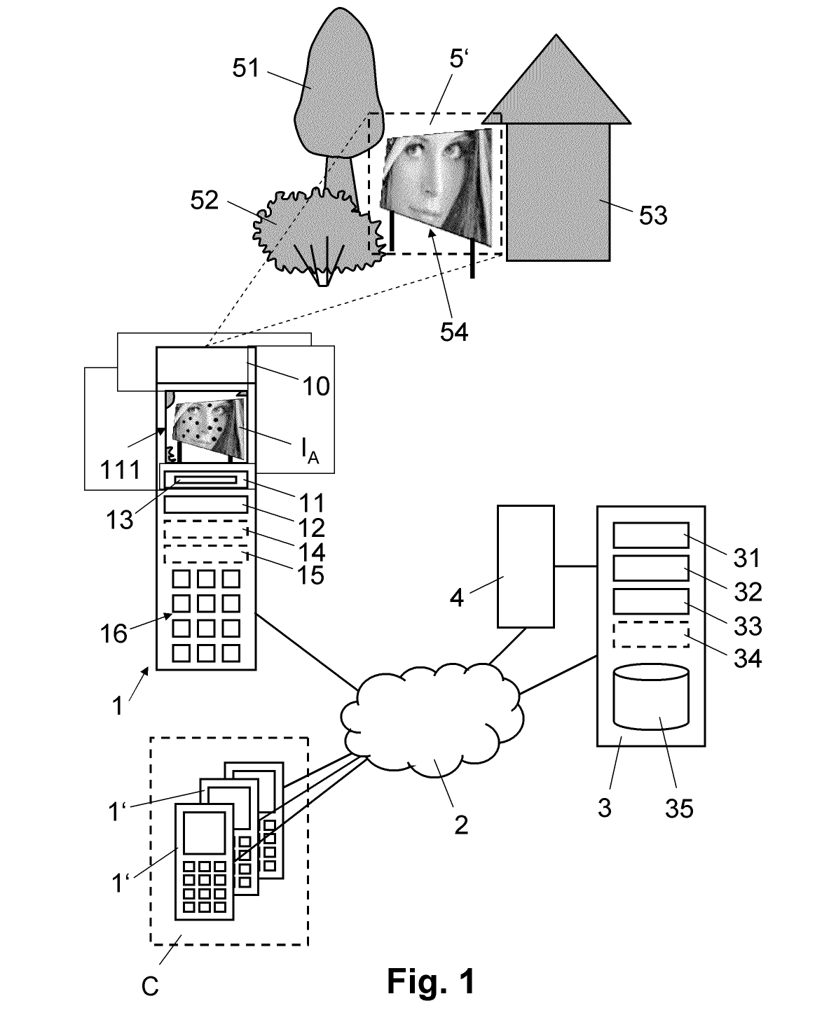

As illustrated in FIG. 1, the system for information retrieval based on images comprises at least one communication terminal 1 and a digital (electronic) camera 10 associated with the communication terminal 1, a remote computer-based recognition server 3, the communication terminal 1 being connectable to the recognition server 3 via a telecommunication network 2.

The telecommunication network 2 includes fixed networks and/or wireless networks. For example, the telecommunication network 2 includes a local area network (LAN), an integrated services digital network (ISDN), the Internet, a global system for mobile communication (GSM), a universal mobile telephone system (UMTS) or another mobile radio telephone system, and/or a wireless local area network (WLAN).

The communication terminal 1 is an electronic device, for example a mobile communication terminal such as a mobile radio telephone, a PDA (Personal Digital Assistant), or a laptop or palmtop computer. The communication terminal 1 may also be integrated in a mobile device such as a car or a fixed device such as a building or a refrigerator. Preferably, camera 10 is connected with the communication terminal 1, e.g. attached or as an integral part in the same housing. The communication terminal 1 includes a display module 11 with a display screen 111, and data entry elements 16, e.g. a keyboard, a touchpad, a track ball, a joystick, button, switches, a voice recognition module or any other data entry elements. The communication terminal 1 further includes functional modules such as control module 12, user interface module 13, an optional image augmentation module 14 and an optional feature description module 15.

In FIG. 1, reference numeral 3 refers to a computer-based recognition server that is connectable via the telecommunication network 2 to telecommunication terminal 1 and to additional communication terminals 1′ of a user community C. In an embodiment, recognition server 3 is connected to a computer-based information server 4 that is connectable via telecommunication network 2 to telecommunication terminal 1. Information server 4 is located on the same computer or on a computer separate from the recognition server 3. The recognition server 3 includes a database 35 and functional modules such as image recognition module 31, image mapping module 32, modification selection module 33 and an optional image augmentation module 34. Furthermore, FIG. 1 illustrates schematically a real world scene 5 with some real world objects, such as a tree 51, a bush 52, a house 53 or a billboard 54. Reference numeral 5′ indicates a query image taken by camera 10 of the billboard 54 in the real world scene 5.

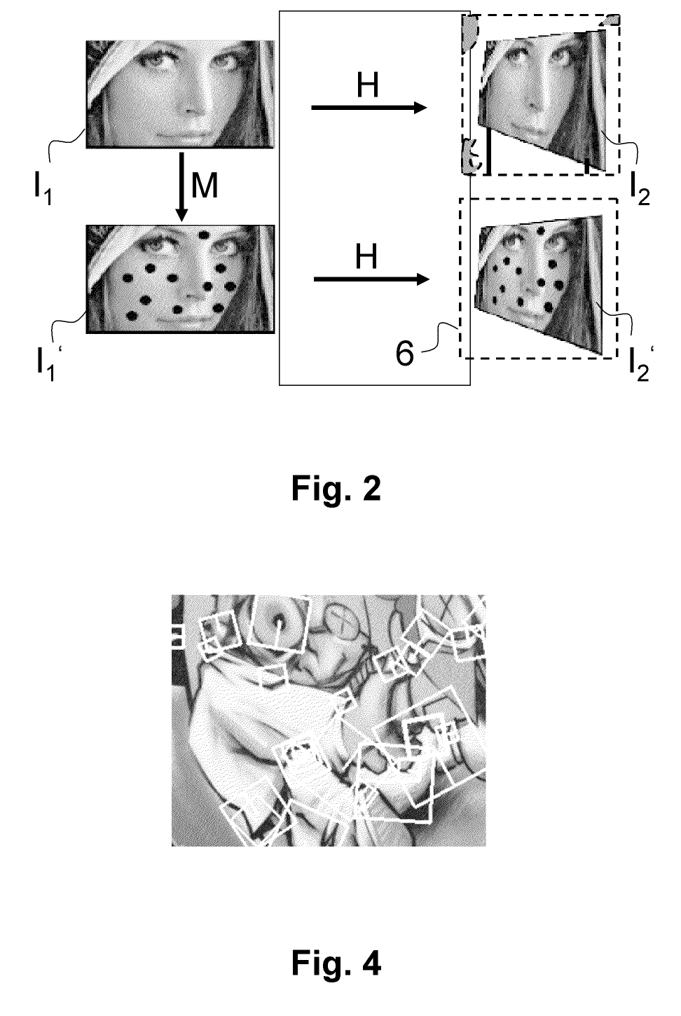

Preferably, the functional modules and the database 35 are implemented as programmed software modules. The computer program code of the software modules is stored in a computer program product, i.e. in a computer readable medium, either in memory integrated in communication terminal 1 or a computer of the recognition server 3, respectively, or on a data carrier that can be inserted into communication terminal 1 or a computer of the recognition server 3, respectively. The computer program code of the software modules controls the processors of the communication terminal or the recognition server, respectively, so that the communication terminal 1 or the recognition server 3, respectively, executes various functions described later in more detail with reference to FIGS. 2 to 6. One skilled in that will understand that the functional modules can be implemented partly or fully by hardware means.

The display module 11 is configured to display captured or augmented images on the display screen 111. The user interface module 13 is configured to visualize on the display screen 11 a graphical user interface and to handle user interactions through the graphical user interface and the data entry elements 16.

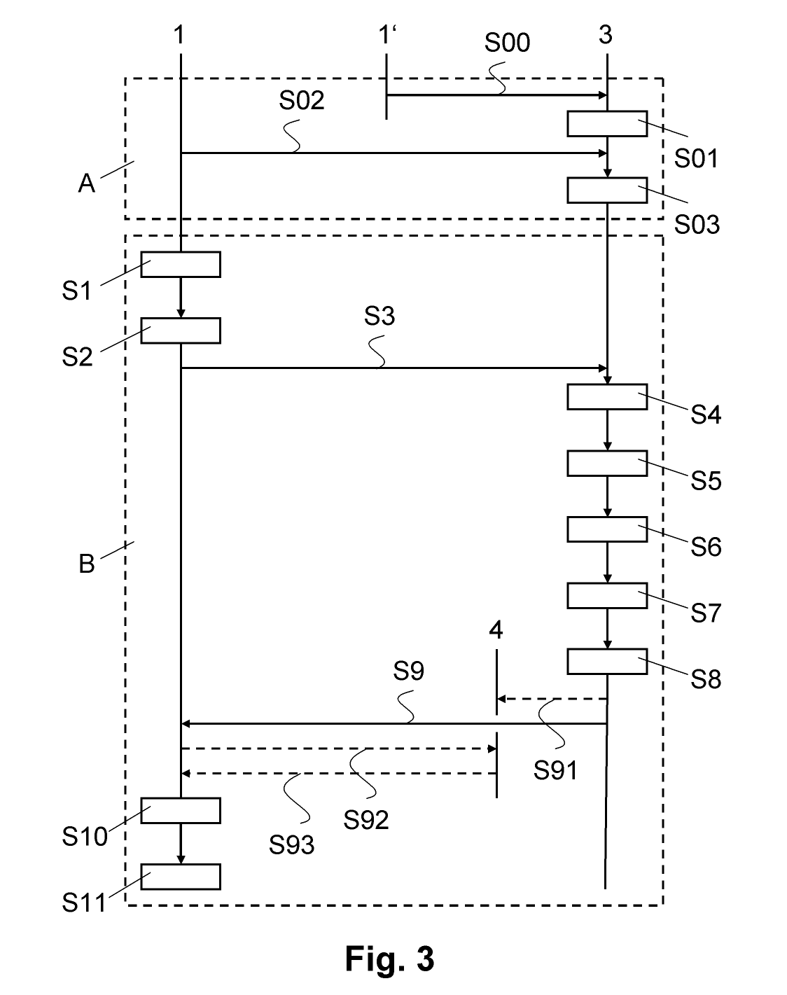

In FIG. 3, block A illustrates preparatory steps performed between communication terminals 1, 1′ and the recognition server 3. In step S00 a communication terminal 1′ associated with user community C transmits community data to the recognition server 3. In step S01, the recognition server 3 stores the received community data in database 35. In step S02 a communication terminal 1 transmits user profile data to the recognition server 3. In step S03, the recognition server 3 stores the received user profile data in database 35. Community data and/or user profile data includes information, e.g. rating information, assigned to certain geographic locations and/or (image) objects, the information may by specific to one user, to a defined group of users, or to a whole community. User profile data may include age, gender, interests and other information about a specific user.

In FIG. 3, block B illustrates an exemplary sequence of steps for information retrieval based on images.

In step S1, the camera 10 is directed by the user towards an area of interest, for example the real world scene 5, specifically billboard 54 in that scene, and the camera 10 is activated to take a single image (photographic mode) or a continuous stream of images (searching or video mode). In the following paragraphs, query image I₂, as illustrated in FIG. 2, relates to the single image taken by the camera 10 in the photographic mode, or to a specific image frame of an image sequence taken by the camera 10 in the video mode.

In step S2, control module 12 prepares query data related to the query image I₂ captured by the camera 10. In a preferred embodiment, the control module activates the feature description module 15 to generate descriptor vectors related to the captured query image I₂. First, the feature description module 15 analyzes the pixels of the captured query image I₂ in order to detect scale-invariant interest points. Subsequently, the feature description module 15 assigns a reproducible orientation to each interest point and computes for each interest point a descriptor vector based on derivatives of pixel values neighboring the interest point. The determination of the descriptor vectors is described later in more detail. In an alternative embodiment, rather than the descriptor vectors, the control module 12 includes the captured query image I₂ in the query data.

Depending on the embodiment, the application and/or user settings or user instructions, the control module 12 includes additional query information in the query data, e.g. geographical location (position) information, day time information, calendar date information, and/or application information such as historical year information, future year information, user instruction information specifying an operation to be performed at the remote recognition server, and/or biomedical information such as blood pressure information, blood sugar level information and/or heart rate information and/or user profile information such as age, gender and/or interests. The geographical location information is determined in the communication terminal 1 by means of a positioning system, e.g. a receiver for GPS (Global Positioning System), GNSS (Global Navigation Satellite System), LPS (Local Positioning System) or Galileo, or from network information, e.g. base station identification or cell identification data in a cell-based mobile radio network. The historical or future year information as well as user instruction information is entered by the user through the user interface module 13 using data entry elements 16. The biomedical information is captured by means of respective biomedical sensors coupled to the communication terminal 1. In a variant, a modifying image is also included with the query data.

In step S3, the query data is transmitted from the communication terminal 1 to the remote recognition server 3. In a variant, the query data is transmitted to more than one (parallel processing) remote recognition servers 3.

In step S4, based on the query data received, the image recognition module 31 identifies a reference image I₁ stored in database 35. In the preferred embodiment, the image recognition module 31 compares the received descriptor vectors related to the query image I₂ with descriptor vectors stored in database 35. If the query data includes additional query information, the image recognition module 31 limits the search for the reference image I₁ to those images in the database 35 that are related to additional query information such as the geographical location, day time and/or calendar date to reduce search and response time. Subsequently, the image recognition module 31 selects from the stored images associated with descriptor vectors corresponding to the received descriptor vectors, the reference image I₁ with interest points that correspond in their geometric arrangement in the image to the interest points of the query image I₂, as defined by the received descriptor vectors. For example, the geometric verification is performed by computing the Fundamental Matrix, the Trifocal Tensor, or by verifying a Homography (for partially planar objects) between the query interest points and the candidate interest points.

In the alternative embodiment, where the query image I₂ is transmitted with the query data rather than the descriptor vectors, the image recognition module 31 identifies the reference image I₁ that corresponds to the query image I₂ by analyzing pixels of the query image I₂ to detect scale-invariant interest points and then assigning a reproducible orientation to each interest point. Subsequently, for each interest point the image recognition module 31 computes a descriptor vector based on derivatives of pixel values neighboring the interest point. The determination of the descriptor vectors is described later in more detail. Then, possibly restricting the search based on additional query information, the image recognition module 31 identifies the reference image I₁ through image matching by comparing the descriptor vectors related to the query image I₂ with the descriptor vectors stored in database 35, as explained before.

In step S5, the image mapping module 32 computes the Homography H, as illustrated in FIG. 2, which transforms the reference image I₁ in the reference plane to the query image I₂ in the projection plane.

A Homography is a general perspective transformation matrix mapping points from one plane to another. Given a plane Π1 and its projection (image) Π2 on the retinal plane of a camera, there exists a unique Homography H that maps all points of Π1 to Π2. This Homography can be estimated with only four point correspondences between the two planes Π1 and Π2. Given a reference image I₁ and its modified counterpart I₁′, and defining the query image I₂ as the projection (image) of the reference image I₁, the Homography H can be computed from point correspondences between the reference image I₁ and the query image I₂. This same Homography H is used to ‘augment’ the query image I₂ with the modified reference image I₁′ and thereby generating the projection image I₂′. The difference to conventional augmented reality consists in the number of dimensions. While augmented reality projects a 3D object in the real world, the present image augmentation approach, based on Homography, deals with 2D objects only.

In step S6, the modification selection module 33 selects the modifying image I₁′. As mentioned above, in one embodiment, the modifying image I₁′ is included in the query data transmitted to the recognition server 3. Preferably however, the modifying image I₁′ is selected from the database 35 based on additional query information included in the received query data. For example, the modifying image I₁′ is selected based on the users current geographical location, the current time and/or date, based on the user's current blood pressure, blood sugar level and/or heart rate, and/or based on specified application specific information such as a historical year, a future year, or a user instruction, or user profile information such as age, gender, interests. In the example shown in FIG. 2, the modifying image I₁′ is the result of a modification M of the reference image I₁. Time-dependent information is useful not only to reduce the search space, but also to specify the response in particular for newspaper headlines. If the user wants the latest news about a topic in the newspaper, then time is an important issue. An example for an application based on biomedical information includes adapting the insulin rates of a diabetic to the current situation, estimated through analysis of the surroundings that are defined by the received descriptor vectors, or estimating the emotional reaction of a person towards a certain image in the context of partner search, advertising campaigns, etc.

In step S7, the image mapping module 32 computes the projection image I₂′ of the modifying image I₁′ selected in step S6 using the Homography H determined in step S5.

Subsequently, an augmented image I_{A} is generated by replacing at least a part of the query image I₂ with a corresponding part of the projection image I₂′. Depending on the embodiment, the augmented image I_{A} is generated in step S8 by augmentation module 34 in the recognition server 3, or the augmented image I_{A} is generated in step S10 by augmentation module 14 in the communication terminal 1. For example, the projection image I₂′ is included in an “empty” bounding box 6 such that the projection image I₂′ can be combined with the original query image I₂ (as referenced by reference numeral 5′ in FIG. 1) without compromising unaltered image objects (e.g. parts of tree 51, bush 52 and house 53) that are visible in the original query image I₂, 5′.

In optional step S91, the projection image I₂′ of the modifying image I₁′ is transferred to information server 4; depending on the embodiment, the projection image I₂′ is transferred to the information server 4 as part of the augmented image I_{A} or as a separate image.

In step S9, the projection image I₂′ or the augmented image I_{A}, respectively, is transmitted to the communication terminal 1; depending on the embodiment, the projection image I₂′ or the augmented image I_{A}, respectively, is transmitted by content as an image or by reference as a link to the respective image stored on the information server 4. For example, the link or the images are transmitted to the communication terminal 1 using HTTP, MMS, SMS, UMTS, etc. The link can trigger various actions. Depending on the definition by a third party, the link provides access to the Internet; activate different processes such as sending multimedia content to a destination, specified by the user or a third party; or set off different object-dependent applications such as generation of a 3D model of the object, panorama stitching, augmenting the source image, etc. In different variants, the link is transmitted to one or more communication terminals, not necessarily to the one that submitted the query image (partner search).

In the case of the transmission by reference, in optional step S92, using the link received in step S9, the control module 12 of the communication terminal 1 accesses the projection image I₂′ or the augmented image I_{A}, respectively, on the information server 4. In optional step S93, the projection image I₂′ or the augmented image I_{A}, respectively, is transmitted from the information server 4 to the communication terminal 1.

In optional step S10, if image augmentation is not performed on the remote recognition server 3, augmentation module 14 of the communication terminal 1 generates the augmented image I_{A} by replacing at least a part of the query image I₂ with the corresponding part of the projection image I₂′, as described above.

In step S11, the display module 11 shows the augmented image I_{A} on display screen 111.

In video mode, block B is executed in continuous repetition, such that individual image frames of the video image sequence taken by the camera 10 are augmented consecutively and continuously with modifying images, thus producing for the user on the display screen 111 an augmented video composed of a sequence of augmented image frames.

Real world objects, e.g. a visual medium such as an electronic display, a billboard 54 or another printed medium, can be provided with real visual markers, e.g. a label or symbol printed on the visual medium, which indicates interactive image sections, or depicted objects that can be viewed with image augmentation, or the presence of hidden interactive image sections, using one defined (global) indicator to communicate the hidden presence.

In a further embodiment, the visual markers are not printed on the real world objects but are made visible for the user in the augmented image I_{A}. In other words, while the camera 10 is directed by the user towards the real world scene 5, the continuous stream of query images is augmented with modifying images I₁′ that comprise visual markers indicative of objects or sections that can be augmented. For example, the visual marker is an icon, a frame, a distinctive color, or an augmented reality object. If the user directs the camera 10 towards a real world object that is provided in the augmented image I_{A} with such a visual marker, e.g. billboard 54, and enters a command using the data entry elements 16, e.g. a single click on a defined key, a query image I₂ is taken of that real world object in photographic mode, augmented in block B, and displayed on display screen 111 as an augmented image I_{A}.

As outlined above, the present invention makes it possible to link real world objects to virtual content using a portable or stationary device equipped with one or more cameras and connected via a wired or wireless connection to one or more recognition server(s).

In one exemplary application, the user takes an image of a poster of car advertisement, specifically of the car or a certain area of interest of the car. This query image is transmitted to the recognition server 3. An augmented image is transmitted back to the user. The augmented image corresponds to the query image, however, through the image augmentation process, the engine of the vehicle, which is not visible on the original poster, is exposed. This application is an example of the above-mentioned x-ray effect.

In another exemplary application, augmented images simulate time travels. For example, an image of an Alpine glacier is taken as a query image and the returned augmented image shows the glacier as it was 40 years ago.

In a further exemplary application, secret messages or hidden art, e.g. associated with buildings or other real world objects, are made visible to the user through the image augmentation process.

The recognition server 3 is also configured to support communities in rating of places such as restaurants, clubs, bars, car repair shops etc. and sharing the rating information based on visual and geographical cues. Thus the recognition server 3 is configured to receive from users and store in the database 35 information associated with and assigned to geographic locations and objects. For example, after a visit to a restaurant, to give a positive rating for the restaurant, using his communication terminal 1 with a built-in camera, the user takes a picture of the outside of the restaurant and sends it, possibly together with the positive rating, to the recognition server 3 or an associated community server on the Internet, for example. Preferably, the communication terminal 1 includes location information with the transmission of the picture. Subsequent users may retrieve the rating information by sending an image of the restaurant as a query image to the recognition server 3. The search for this query may be further limited with user profile information to restrict the results to information (e.g. ratings) that were given by users with a profile similar to the one of the querying user.

### Generating the Descriptor Vectors

As outlined above, the search for discrete image correspondences can be divided into three main steps. First, interest points are selected at different scales at distinctive image locations. Next, the neighborhood of every interest point is represented by a descriptor. This descriptor is to be distinctive and at the same time be robust to noise, detection errors and geometric and photometric deformations. Finally, the descriptors are matched between different images. The matching is typically based on a distance between the vectors, e.g. the evaluation of the Euclidean distance.

There are many interest point detectors proposed in the literature, see References [1 . . . 7], each one of different nature with specific properties with respect to form appearance, and degree of invariance (scale, affine, perspective). For the proposed method and system, the nature of the interest point detector is not crucial. Preferably, more than one of these detectors is used simultaneously in order to cover multiple different interest-point properties (blobs, corners, etc.) and invariances.

The proposed method and system use a method for deriving a descriptor of an interest point in an image having a plurality of pixels, the interest point having a location in the image, a scale (size), and an orientation. The method for deriving a descriptor comprises: identifying a quadratic descriptor window around the interest point aligned with the orientation of the interest point and of scale-dependent size (see FIG. 4), the descriptor window comprising a set of pixels; inspecting derivatives within the descriptor window of the interest point in x- and y-direction having a fixed relation to the orientation and using at least one digital filter to thereby generate first order derivatives for each direction independently; and generating a multi-dimensional descriptor comprising elements, each element being a statistical evaluation of the first order derivatives from only one direction in a rectangular, two-dimensional region of a specific size.

These multi-dimensional descriptors (descriptor vectors) are extracted independently for a set of interest points in every image.

### Statistical Descriptor

The descriptor that is provided is composed of statistical information of the image's first order derivatives in two, mutually orthogonal directions. Using derivatives increases the invariance of the descriptor towards linear lighting changes of the photographed environment. In order to construct a descriptor for a given interest point, the first step consists of fixing a reproducible orientation around the interest point based on pixel information within a circular region around the interest point. Then a quadratic region (descriptor window) is aligned to the selected orientation, and the descriptor is extracted from this localized and aligned quadratic region. The interest point is obtained by any suitable method outlined in References [1 . . . 7].

### Orientation Assignment

In order to be invariant to rotation, a reproducible orientation a, is identified for each detected interest point at scale s. The orientations are extracted in a two-dimensional region in the image around the interest point. This region is a discretized circular area around the interest point, similar to References [6] and [7], of a radius, which is a multiple of the detected scale s, e.g. 4s.

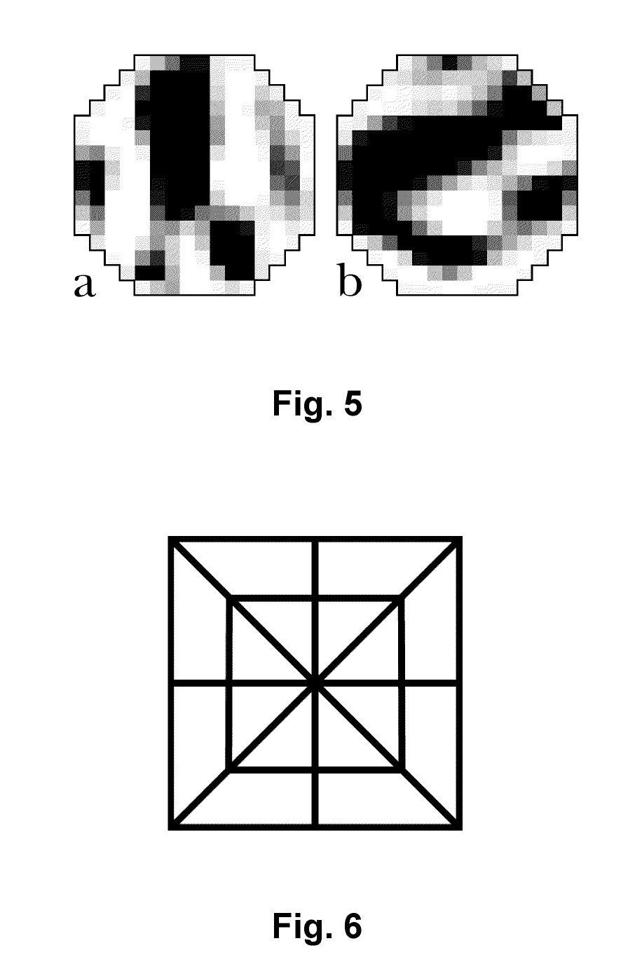

From this region, the derivatives in x- and y-direction are calculated (see FIG. 5).

The resulting derivatives dx(x) and dy(x) in any point x within the circular region are clustered according to their sign and relative value in eight bins Bᵢ, i={1, 2, 3, . . . , 8} (see Table 1). The derivatives are then independently summed up for every bin resulting in two sums Σdx(x) and Σdy(x) per bin. In order to determine the dominant orientation, the gradients for 16 different configurations are considered. These gradients are computed for each bin B₁, . . . , B₈ and additionally for each two neighboring bins e.g. B₁ and B₂, B₂ and B₃, . . . B₈ and B₁. The norm of the gradients t is computed for every combination using Σdx(x) and Σdy(x) of every single bin or summed with the neighboring bin for the additional cases.

TABLE 1
Binning of the derivatives.

| | | | |
|---|---|---|---|
| B₁ | dx(x) > 0 | dy(x) > 0 | \|dy(x)\| > \|dx(x)\| |
| B₂ | dx(x) > 0 | dy(x) > 0 | \|dy(x)\| ≦ \|dx(x)\| |
| B₃ | dx(x) > 0 | dy(x) ≦ 0 | \|dy(x)\| ≦ \|dx(x)\| |
| B₄ | dx(x) > 0 | dy(x) ≦ 0 | \|dy(x)\| > \|dx(x)\| |
| B₅ | dx(x) ≦ 0 | dy(x) ≦ 0 | \|dy(x)\| > \|dx(x)\| |
| B₆ | dx(x) ≦ 0 | dy(x) ≦ 0 | \|dy(x)\| ≦ \|dx(x)\| |
| B₇ | dx(x) ≦ 0 | dy(x) > 0 | \|dy(x)\| ≦ \|dx(x)\| |
| B₈ | dx(x) ≦ 0 | dy(x) > 0 | \|dy(x)\| > \|dx(x)\| |

The orientation α=arctan(Σdx(x)/Σdy(x)) of the dominant gradient is used as the orientation of the interest point. This orientation α is used to build the descriptor.

### Descriptor

After having found the dominant orientation for an interest point, the neighboring pixel values are described by a unique and distinctive descriptor, similar to References [6] and [7]. The extraction of the descriptor includes a first step consisting of constructing a descriptor window centered on the interest point, and oriented along the orientation selected by the orientation assignment procedure above (see FIG. 4). The size of this window also depends on the scale s of the interest point. The new region is split up into smaller sub-regions as shown in FIG. 6.

For each sub-region, four descriptor features are calculated. The first two of these descriptor features are defined by the mean values of the derivatives dx′(x) and dy′(x) within the sub-region. dx′(x) and dy′(x) are the rotated counterparts of the derivatives in x- and y-direction dx(x) and dy(x), with respect to the orientation α as defined above.

dx′(x)=dx(x)sin(α)+dy(x)cos(α)

dy′(x)=dx(x)cos(α)−dy(x)sin(α)

The third and fourth descriptor features per sub-region are the statistical variances of the derivatives in x- and y-direction. Alternatively, these four descriptor features can be the mean values of positive and negative derivatives in x- and y-direction. Another alternative is to consider only the maximum and minimum values of the derivatives in x- and y-direction within the sub-regions.

Summarizing the above, the descriptor can be defined by a multidimensional vector v where the different components depend on the derivatives in x- and y-direction with respect to the orientation of the interest point (descriptor window). The following table shows the different alternatives for a given sub-region.

TABLE 2
Different alternatives for computing the
basic descriptor for every sub-region.

| Descriptor | | | |
|---|---|---|---|
| feature | Alternative 1 | Alternative 2 | Alternative 3 |
| v₁ | mean of dx′ | mean of dx′ if dx′ > 0 | minimum of dx′ |
| v₂ | mean of dy′ | mean of dx′ if dx′ ≦ 0 | maximum of dx′ |
| v₃ | variance of dx′ | mean of dy′ if dy′ > 0 | minimum of dy′ |
| v₄ | variance of dy′ | mean of dy′ if dy′ ≦ 0 | maximum of dy′ |

Constructing the four basic descriptor features for every of the 16 sub-regions as defined above, results in a 64-dimensional descriptor for every interest point.

Matching

In a query/retrieval process, the descriptors are matched as follows. Given a multitude of labeled reference images of a set of different objects, and a query image an object contained in the same set. Detecting the specific object figuring on the query image consists of three steps. First, the interest points and their respective descriptors are automatically detected in every image (reference images and query image). Then, the query image is pair wise compared to the reference images by computing the Euclidean distance between all possible configurations of the descriptor vectors of the image pairs. A match between descriptor vectors is found when the Euclidean distance between the latter is smaller than a certain threshold which can be a fixed value or adaptive. This step is repeated for all image pairs formed with the set of reference images on one side and the query image on the other side. The reference image yielding the maximum number of matches with the query image is considered to contain the same object as in the query image. The label of the reference image is then used to identify the object figuring on the query image. In order to avoid false recognitions due to high numbers of accidental mismatches, the interest point correspondences can be verified geometrically using a Homography for planar (or piecewise planar objects), or the Fundamental Matrix for general 3D objects.

The foregoing disclosure of the embodiments of the invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents. Specifically, in the description, the computer program code has been associated with specific software modules, one skilled in the art will understand, however, that the computer program code may be structured differently, without deviating from the scope of the invention. Furthermore, the particular order of the steps set forth in the specification should not be construed as limitations on the claims.

### REFERENCES

1. Lindeberg T.: Feature detection with automatic scale selection. IJCV 30(2)(1998) 79-116.
2. Mikolajczik, K., Schmid, C.: An affine invariant interest point detector. ECCV (2002) 128-142.
3. Tuytelaars, T. Van Gool, L.: Wide baseline stereo based on local affinely invariant regions. BMVC (2000) 412-422.
4. Matas, J., Chum, O., M., U., Pajdla, T.: Robust wide baseline stereo from maximally stable extremal regions. BMVC (2002) 384-393.
5. Harris, C., Stephens, M.: A combined corner and edge detector: Proceedings of the Alvey Vision Conference. (1988) 147-151.
6. Lowe, D.: Distinctive image features from scale-invariant key points. IJCV 60 (2004) 91-110.
7. Bay, H., Tuytelaars, T., Van Gool, L.: SURF: Speeded Up Robust Features. ECCV (2006) 404-417.

1.-23. (canceled)

24. A method of information retrieval based on images, the method comprising:
receiving query data related to a first image;
identifying a reference image based on the query data;
computing in a recognition server a perspective transformation matrix based on the reference image and the query data, the perspective transformation matrix mapping the reference image to the first image;
selecting a second image in the recognition server;
computing in the recognition server a projection image of the second image using the perspective transformation matrix;
generating an augmented image by replacing at least a part of the first image with at least a part of the projection image; and
transmitting the augmented image for display.

25. The method according to claim 24, wherein receiving the query data includes receiving the first image; wherein identifying the reference image includes determining the reference image corresponding to the first image; and wherein computing the perspective transformation matrix includes computing the perspective transformation matrix based on the reference image and the first image.

26. The method according to claim 25, wherein identifying the reference image includes analyzing pixels of the first image to detect interest paints having invariance, assigning a reproducible orientation to each interest point, computing for each interest point a descriptor vector based on derivatives of pixel values neighboring the interest point, and image matching by comparing the descriptor vectors related to the first image with descriptor vectors stored in a database of the recognition server, and selecting from stored images having corresponding descriptor vectors the reference image with interest points that correspond geometrically to the interest points of the first image.

27. The method according to claim 24, wherein the method further comprises determining the query data related to the first image by analyzing pixels of the first image to detect interest points having invariance, by assigning a reproducible orientation to each interest point, and by computing for each interest point a descriptor vector based on derivatives of pixel values neighboring the interest point; and wherein identifying the reference image includes image matching by comparing the descriptor vectors related to the first image with descriptor vectors stored in a database of the recognition server, and selecting from stored images having corresponding descriptor vectors the reference image with interest points that correspond geometrically to the interest points of the first image.

28. The method according to claim 24, wherein receiving query data further includes receiving additional query information; and wherein selecting the second image is executed using the additional query information, the additional query information including at least one of geographical position information, day time information, calendar date information, historical year information, future year information, user instruction information specifying an operation to be performed at the recognition server, blood pressure information, blood sugar level information, heart rate information and user profile information.

29. The method according to claim 24, wherein the first image is part of a video sequence; and wherein the part of the projection image that replaces the corresponding part of the first image is kept fixed with respect to a real world object shown in the first image while the video sequence is being recorded and/or while the real world object is moving.

30. The method according to claim 24, wherein the second image comprises a visual marker indicative of interactive image sections; and wherein displaying the augmented image includes displaying the visual marker as part of the augmented image.

31. The method according to claim 30, further comprising receiving from a user a user instruction associated with the visual marker as part of the augmented image at a terminal, the user instruction being associated with the visual marker; and receiving the user instruction in the recognition server; based on the user instruction, in the recognition server, selecting a third image and/or modifying the reference image as the third image; computing in the recognition server a projection image of the third image using the perspective transformation matrix; and generating a further augmented image by replacing at least a part of the first image with at least a part of the projection image of the third image.

32. The method according to claim 24, wherein the second image comprises a sequence of images; and wherein displaying the augmented image includes displaying a sequence of images as part of the augmented image.

33. The method according to claim 24, wherein the second image is a modified version of the reference image.

34. The method according to claim 24, wherein the method further comprises transmitting the second image from a terminal to the recognition server as part of the query data.

35. A system for information retrieval based on images, the system comprising:
a recognition server configured to receive query data related to a first image from a communication terminal, and to identify a reference image based on the query data;
wherein the recognition server is further configured to compute a perspective transformation matrix based on the reference image and the query data, the perspective transformation matrix mapping the reference image to the first image, to select a second image, and to compute a projection image of the second image using the perspective transformation matrix; and
the system is further configured to generate the augmented image by replacing at least a part of the first image with at least a part of the projection image,

36. The system according to claim 35, wherein the recognition server is further configured to receive the first image as part of the query data, to identify the reference image corresponding to the first image, and to compute the perspective transformation matrix based on the reference image and the first image.

37. The system according to claim 36, wherein the recognition server is further configured to identify the reference image by analyzing pixels of the first image to detect interest points having invariance, by assigning a reproducible orientation to each interest point, by computing for each interest point a descriptor vector based on derivatives of pixel values neighboring the interest point, and through image matching by comparing the descriptor vectors related to the first image with descriptor vectors stored in a database of the recognition server, and by selecting from stored images having corresponding descriptor vectors the reference image with interest points that correspond geometrically to the interest points of the first image.

38. The system according to claim 35, wherein the communication terminal is further configured to determine the query data related to the first image by analyzing pixels of the first image to detect interest points having invariance, by assigning a reproducible orientation to each interest point, and by computing for each interest point a descriptor vector based on derivatives of pixel values neighboring the interest point; and the recognition server is further configured to identify the reference image through image matching by comparing the descriptor vectors related to the first image with descriptor vectors stored in a database of the recognition server, and selecting from stored images having corresponding descriptor vectors the reference image with interest points that correspond geometrically to the interest points of the first image.

39. The system according to claim 35, wherein the recognition server is further configured to receive additional query information with the query data related to the first image, the additional query information including at least one of geographical position information, day time information, calendar date information, historical year information, future year information, user instruction information specifying an operation to be performed at the recognition server, blood pressure information, blood sugar level information, and heart rate information; and the recognition server is further configured to select the second image using the additional query information.

40. The system according to claim 35, wherein the system further comprises user profile information; and the recognition server is further configured to select the second image using the user profile information.

41. The system according to claim 35 further comprising a client software configured to run on a communication terminal, wherein the communication terminal is further configured to take the first image as part of taking a video sequence; and the image augmentation module is further configured to keep fixed the part of the projection image that replaces the corresponding part of the first image with respect to a real world object shown in the first image while a camera is taking the video sequence and/or while the real world object is moving

42. The system according to claim 35, wherein the second image comprises a visual marker indicative of interactive image sections; and wherein the augmented image comprises the visual marker.

43. The system according to claim 42 further comprising a client software configured to run on a communication terminal, wherein the communication terminal is further configured to receive from a user a user instruction while displaying the visual marker as part of the augmented image, the user instruction being associated with the visual marker, and to transmit the user instruction to the recognition server; the recognition server is further configured to select a third image and/or to modify the reference image as the third image, based on the user instruction, and to compute a projection image of the third image using the perspective transformation matrix; and the recognition server is further configured to generate a further augmented image by replacing at least a part of the first image with at least a part of the projection image of the third image.

44. The system according to claim 35, wherein the second image comprises a sequence of images; and wherein the augmented image comprises the sequence of images.

45. The system according to claim 35, wherein the second image is a modified version of the reference image.

46. The system according to claim 35, further comprising a client software configured to run on a communication terminal, wherein the communication terminal is further configured to transmit to the recognition server the second image with the query data.

47. The method according to claim 24, wherein the first image is a digital photograph taken with a digital camera.

48. The method according to claim 24, wherein the perspective transformation matrix is a Homography.
